(19) United States
(12) Patent Application Publication
(10) Pub. No.: US 2006/0207451 A1
(43) Pub. Date: Sep. 21, 2006

(54) Mobile navigator having locked braces

(75) Inventors: Li-Sen Chen, Gueishan Township (TW); Chien-Yu Hsu, Gueishan Township (TW); Chang-Yi Li, Gueishan Township (TW)

Correspondence Address: TROXELL LAW OFFICE PLLC, SUITE 1404, 5205 LEESBURG PIKE, FALLS CHURCH, VA, 22041, US

(73) Assignee: Speed Tech Corp.

(21) Appl. No.: 11/356,089

(22) Filed: Feb. 17, 2006

(30) Foreign Application Priority Data
Mar. 18, 2005 (TW) 094204169

(51) Int. Cl. B41F 5/00

(52) U.S. Cl. 101/216

(57) ABSTRACT

By using hooks and slots, the present invention strengthens the robustness of a support used in a navigator for a mobile and the support is assembled with ease. Moreover, problems on assembling the support are solved by the guidance of the hooks.

### FIELD OF THE INVENTION

The present invention relates to a mobile navigator; more particularly, relates to improving a robustness of a supporting element of the navigator.

### DESCRIPTION OF THE RELATED ART

As shown in FIG. 7 and FIG. 8, a general mobile navigator uses a supporting frame 4, comprising a first frame 41 and a second frame 42. A shaft 411 is set at the center of the first frame 41, where a socket part 412 is deposed on an end surface of the shaft 411 and first cantilever beams 413 are set at two sides of the shaft 411. A receiving hole 414 is located at an end surface of the first cantilever beam 413; a supporting plate 415 is set at a side of the first cantilever beam 413 near the receiving hole 414; and, a through hole 416 is located on the supporting plate 415. A receptacle 421 is set at center of the second frame 42, where a connection hole 422, corresponding to the socket part 412, is deposed on an end surface of the receptacle 421 and second cantilever beams 423 are set at two sides of the receptacle 421. A protruding column 424, corresponding to the receiving hole 414 of the first cantilever beam 413, is located at an end surface of the second cantilever beam 423; a hook 425 is set at a side of the second cantilever beam 423 near the protruding column 424; and, the hook 425 is locked to the through hole 416 on the supporting plate 415. Thus, a supporting frame 4 used in a general mobile navigator is formed.

Because the supporting frame 4 of the prior art is formed by solely inserting the socket part 412, the protruding column 424 and the hook 425 into the connection hole 422, the receiving hole 414 and the through hole 416, the robustness of the supporting frame 4 is not strong. When a down force is exerted onto the supporting frame 4 in use, the support for the first and the second frames 41, 42 may not be enough and so the frames 41, 42 may be broken apart at the place where the frames 41, 42 connect to each other originally. Additionally, the structure of the prior art is complex and so is not assembled easily together with some problems quite often happened on assembling the prior art. Hence, the prior art does not fulfill users' requests on actual use.

### SUMMARY OF THE INVENTION

The main purpose of the present invention is to easily assemble a supporting element of a mobile navigator and to improve a robustness of the supporting element.

To achieve the above purpose, the present invention is a mobile navigator having locked braces, comprising a metal cylinder, a supporting element and a plurality of terminals, where the supporting element comprises a first brace and a second brace; each of the two braces has a shaft to be sheathed with the metal cylinder; an assembling element is deposed on an end surface of one shaft and a corresponding assembling hole is located on an end surface of the other shaft; two cantilever beams are set at two sides of each shaft; two locking parts are respectively deposed on two end surfaces of two cantilever beams and corresponding locking holes are located on two end surfaces of the other two cantilever beams; and the terminals are fixed on the supporting element. Accordingly, a novel mobile navigator having locked braces is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a perspective view showing a preferred embodiment according to the present invention;

FIG. 2 is a structural view of the preferred embodiment;

FIG. 3 and FIG. 4 are perspective views showing its braces;

FIG. 5 is a view showing an assembly of the preferred embodiment;

FIG. 6 is a sectional view of the assembly;

FIG. 7 is a perspective view of a prior art; and

FIG. 8 is a structural view of the prior art.

### DESCRIPTION OF THE PREFERRED EMBODIMENT

The following description of the preferred embodiment is provided to understand the features and the structures of the present invention.

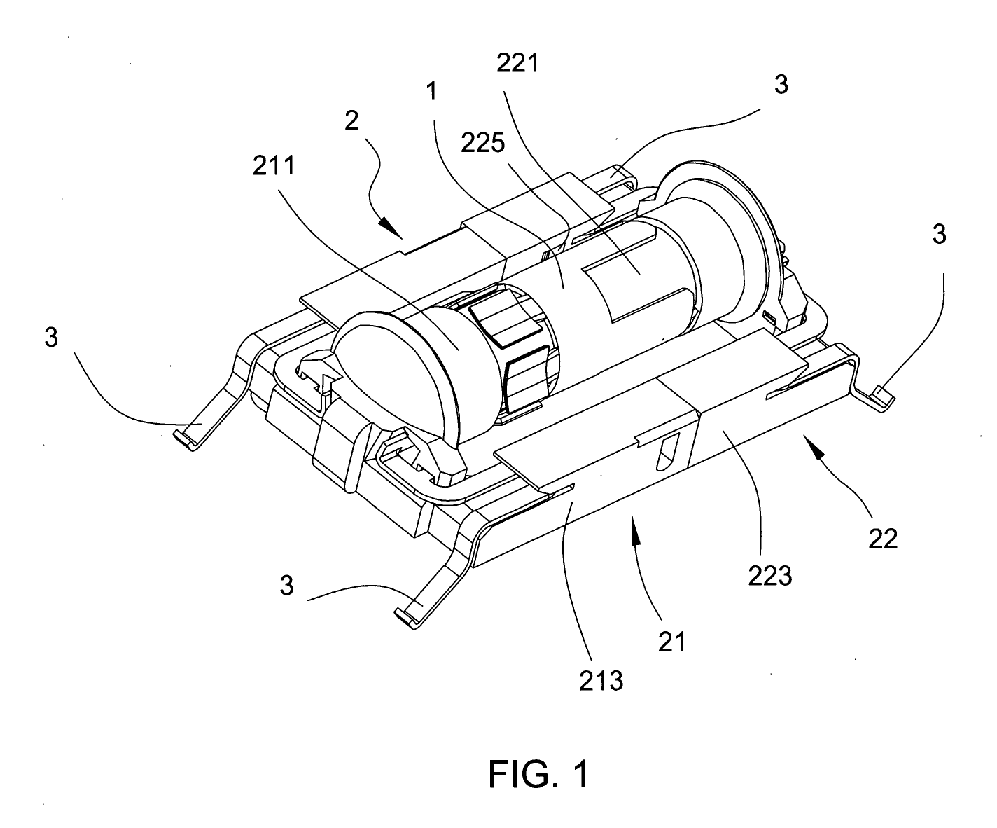

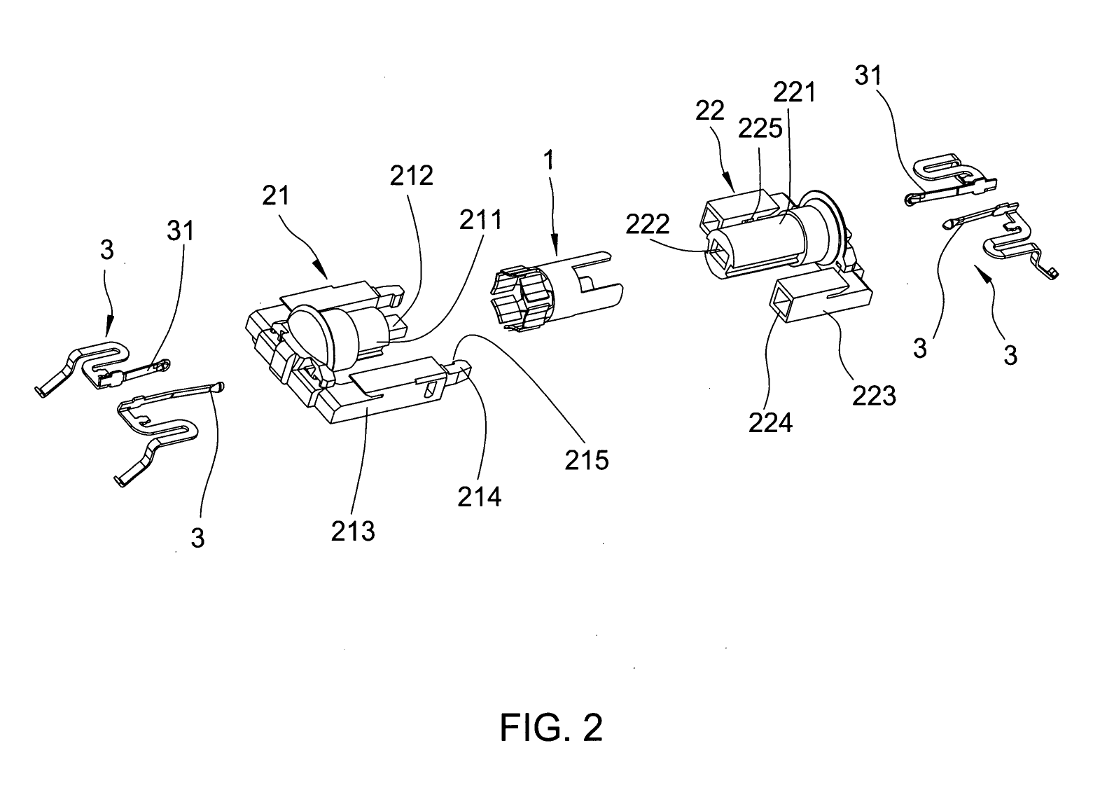

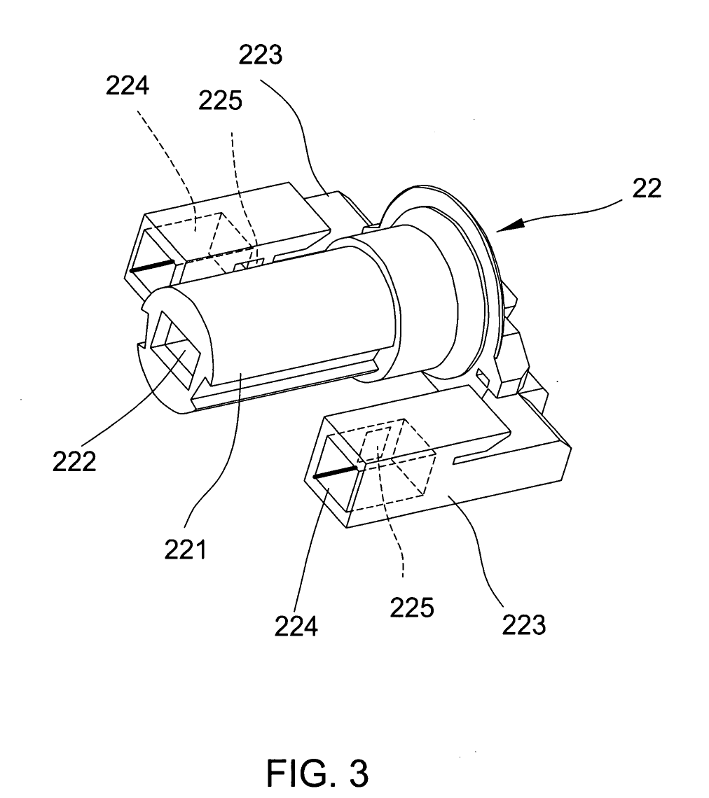

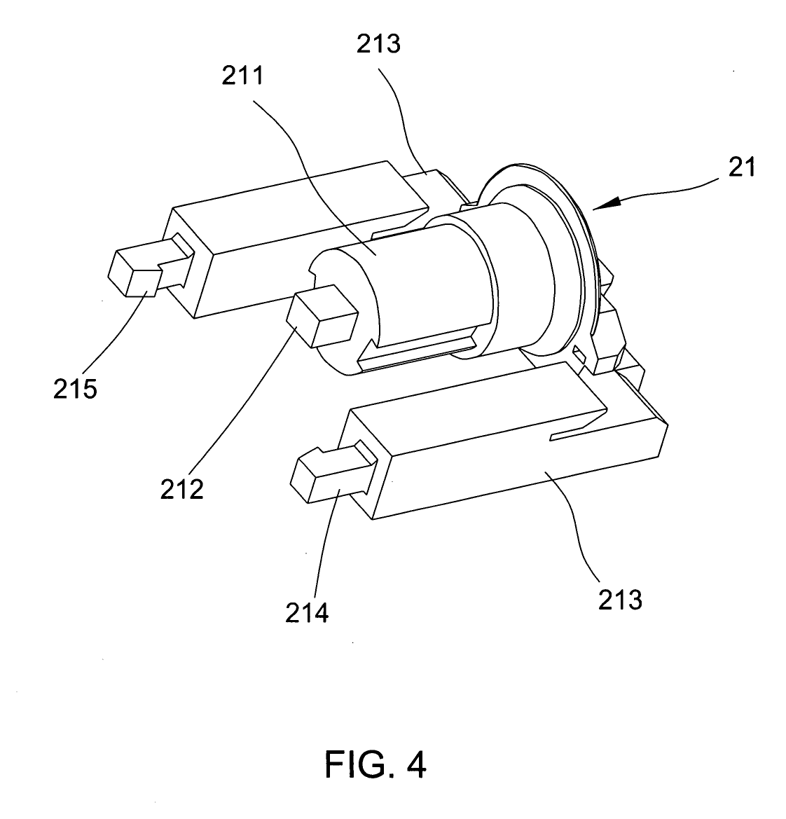

Please refer to FIG. 1 till FIG. 4, which are a perspective and a structural views showing a preferred embodiment and perspective views showing its braces, according to the present invention. As shown in the figures, the present invention is a mobile navigator having locked braces, comprising a metal cylinder 1, a supporting element 2 and a plurality of terminals 3, where the components are easily assembled and the robustness of the supporting element 2 is improved by inserting an assembling element 212 into a corresponding assembling hole 222 and by locking locking parts 214 to corresponding locking holes 224.

The metal cylinder 1 is a hollow cylinder. The supporting element 2 comprises a first brace 21 and a second brace 22 to fix the metal cylinder 1. Each of the braces 21, 22 has a shaft 211, 221 at center to be sheathed with the metal cylinder 1. An assembling element 212 of a protruding column is deposed on an end surface of one shaft 211. An assembling hole 222 corresponding to the assembling element 212 is deposed on an end surface of the other shaft 221. Each shaft 211, 221 has two cantilever beams 213, 223 at two sides of the shaft 211, 221. Two cantilever beams 213 of one shaft 211 have a locking part 214 at an end surface of each cantilever beam 213. The locking part 214 has a hook 215 slightly sloping toward a side at an end of the locking part 214. Two cantilever beams 223 of the other shaft 221 have a locking hole 224 at an end surface of the cantilever beam 223. The locking hole 224 has a slot 225 on a side wall of the locking hole 224. The terminals 3 are fixed on the supporting element 2. Each terminal 3 has a contactor 31 inserted into the metal cylinder 1 from either end surface of the metal cylinder 1 to be contacted with the inner surface of the metal cylinder 1. Hence, with the above structure, a novel mobile navigator having locked braces is obtained.

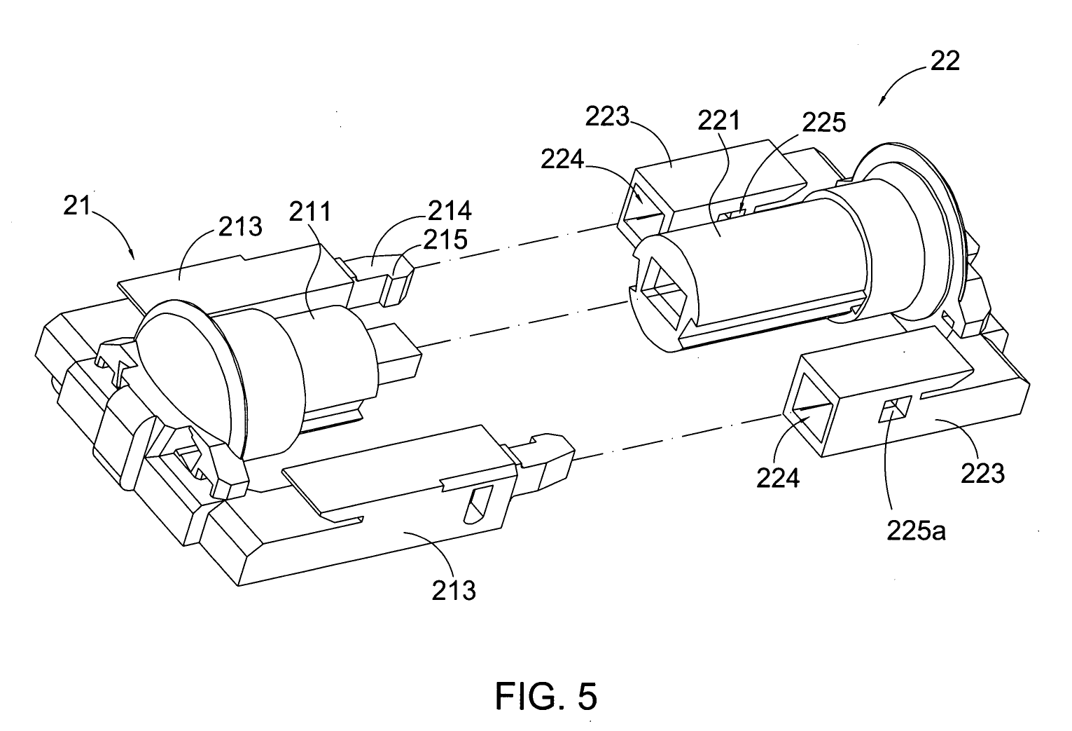

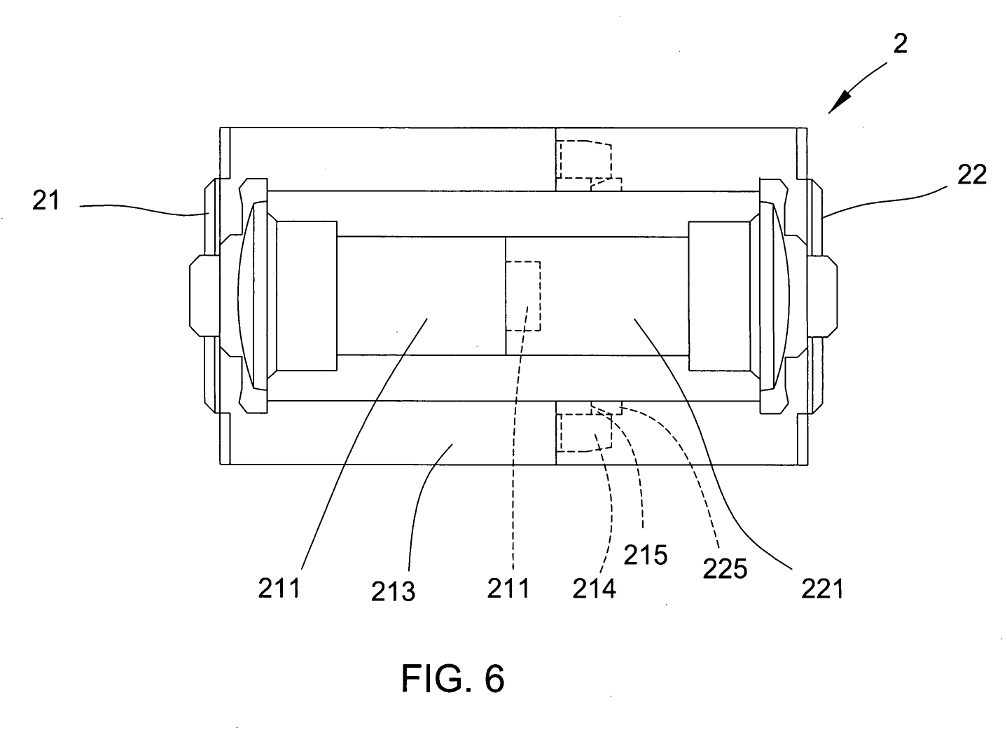

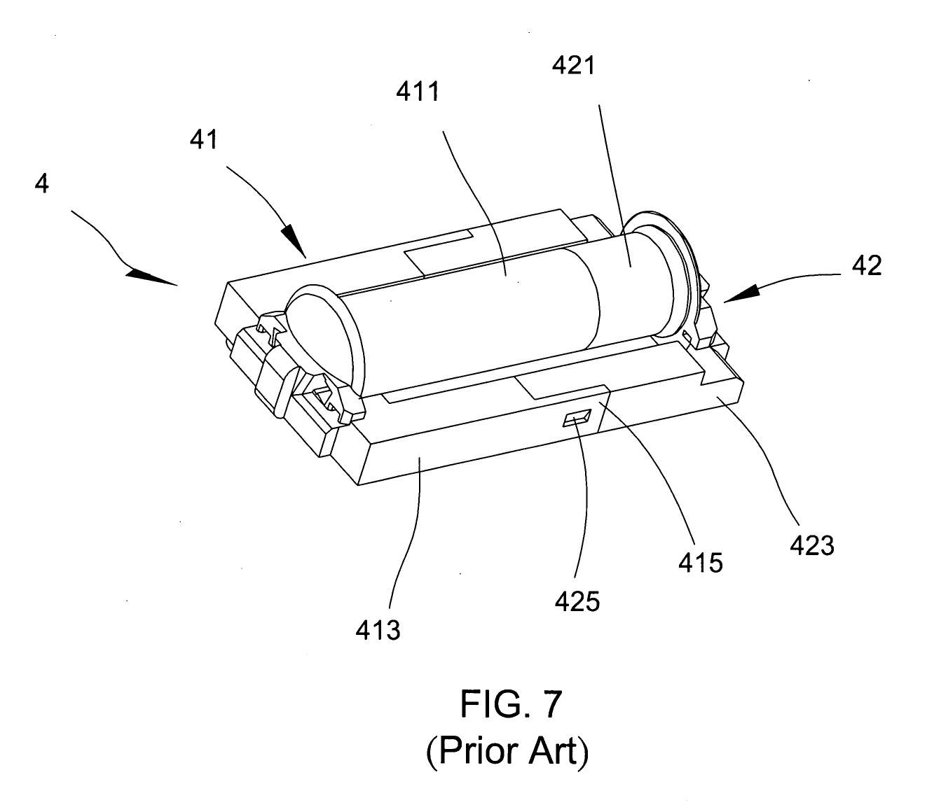

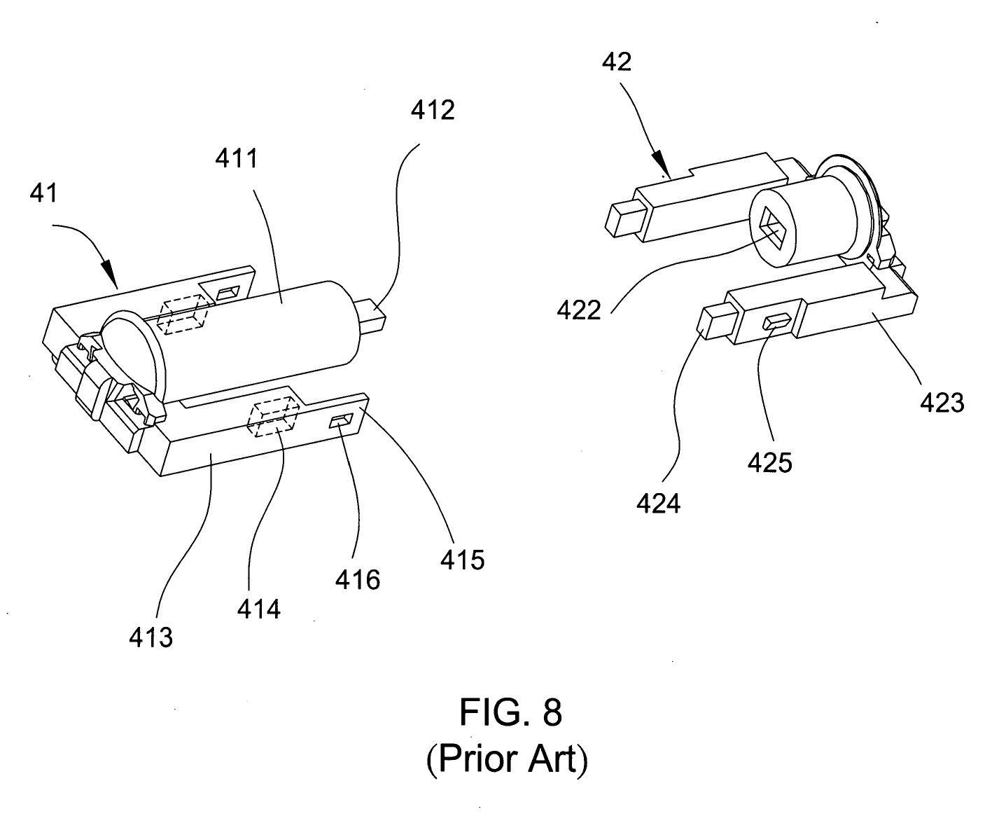

Please refer to FIG. 5 and FIG. 6, which are a view showing an assembly of the preferred embodiment and its sectional view. As shown in the figures, when assembling a first and a second braces 21, 22 of a supporting element 2, an assembling element 212, being a protruding column, of a shaft 211 on the first brace 21 is inserted into an assembling hole 222 of another shaft 221 on the second brace 22; and, at he same time, locking parts 214 deposed respectively on two end surfaces of two cantilever beams 213 are respectively inserted into corresponding locking holes 224 on two end surfaces of the other two cantilever beams 223. In addition, a hook 215 at a side of the locking part 214 is locked to a corresponding slot 225 at a side wall of the locking hole 224. Thus, the first and the second braces are easily assembled for obtaining the supporting element 2. Besides, by inserting the assembling element 212 and the locking parts 214 into the assembling hole 222 and the locking holes 224 respectively and by solving assembly problems through the guidance of the hooks 215 of the locking parts 214, the entire supporting element 2 obtains a strong support and its robustness is improved as well. In the other hand, a slot 225a can also be set on a surface of the cantilever beam 223 to be locked with a proper hook 215.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A mobile navigator having locked braces, comprising
(a) a metal cylinder, said metal cylinder being a hollow cylinder;
b) a supporting element, said supporting element fixing said metal cylinder, said supporting element comprising
a first brace and a second brace, said first brace and said second brace comprising
(i) a first shaft and a second shaft, said first shaft and said second shaft being located at centers of said first brace and said second brace respectively, said first shaft and said second shaft being assembled together to be sheathed with said metal cylinder, said first shaft and said second shaft having
an assembling element, said assembling element being deposed on an end surface of a shaft selected from a group consisting of said first shaft and said second shaft; and
an assembling hole, said assembling hole being deposed at an end of the other shaft, said assembling hole corresponding to said assembling element; and
(ii) cantilever beams, each two of said cantilever beams being respectively located at both sides of each of said first shaft and said second shaft, said cantilever beams comprising
two locking parts, said locking parts being deposed at end surfaces of two cantilever beams, said locking part having
a hook, said hook being deposed at a side of said locking part; and
two locking holes, said locking holes being deposed at end surfaces of the other two cantilever beams, said locking holes corresponding to said locking parts, said locking hole having
a slot, said slot being deposed at a side of said locking hole to be locked with said hook; and
(c) a plurality of terminals, said terminal being fixed on said supporting element, said terminal having
a contactor, said contactor being inserted into said metal cylinder from an end surface of said metal cylinder to be contacted with an inner surface of said metal cylinder.

2. The mobile navigator according to claim 1, wherein said assembling element is a protruding column.
